(19) United States
(12) Patent Application Publication
(10) Pub. No.: US 2012/0230030 A1
(43) Pub. Date: Sep. 13, 2012

(54) Light Housing

(75) Inventors: Jonathan Edward Miller, Los Angeles, CA (US); Robert Bruce Rutherford, Santa Monica, CA (US)

(73) Assignee: HIVE LIGHTING, INC., Los Angeles, CA (US)

(21) Appl. No.: 13/417,116

(22) Filed: Mar. 9, 2012

Related U.S. Application Data
(60) Provisional application No. 61/451,305, filed on Mar. 10, 2011.

(51) Int. Cl. F21V 21/00; F21V 29/00; F21V 15/00

(52) U.S. Cl. 362/249.01; 362/362; 362/373

(57) ABSTRACT

A hexagonal shaped light housing that allows for the removable interconnection of multiple housings through the use of connectors, such as grip, bolts, locking pegs, mating grooves and or screws.

### CROSS-REFERENCE TO RELATED APPLICATIONS

This application is a non-provisional application that claims priority from U.S. Ser. No. 61/451,305, filed Mar. 10, 2011, the disclosure of which is specifically incorporated herein by reference.

### FIELD OF THE INVENTION

The present invention is in the technical field of entertainment lighting. More particularly, the present invention is in the technical field of entertainment lighting housing design.

### BACKGROUND OF THE INVENTION

Current cylindrical or rectangular housings used for high intensity lighting for image capture, including film and television sets, as well as theatrical and event lighting, are unable to combine individual units into larger units through the combination of modular housings, nor are they able to form hexagonal patterns, which become self-supporting as they expand into tessellation patterns.

### SUMMARY OF THE INVENTION

The present invention is generally directed to a light housing containing a light within it which has six equal external sides that form a rectangular outer side shape of the housing and at least one such side, and preferably all six, have a connector for allowing additional identical light housings to be connected to the light housing. When multiple light housings are connected together they can form a tessellation array of two or more light housings, one example of such an array having seven light housings arranged such that one is in the center and each of its outer sides is connected to another light housing. An individual light housing can have a heat sink in its rear and a ventilation means for dissipating heat.

Accordingly, it is a primary object of this invention to provide an improved entertainment lighting system made up of easily connectable modular units.

This and further objects and advantages will be apparent to those skilled in the art in connection with the drawings and the detailed description of the invention which follows.

### BRIEF DESCRIPTION OF THE DRAWINGS

FIG. 1 is a front view of a possible embodiment of the light housing of the present invention;

FIG. 2 is a side view of a possible embodiment of the light housing of FIG. 1.

FIG. 3 is an illustration of an example of the present invention in accordance with one of the embodiments as disclosed herein, illustrating one possible embodiment of the fixture creating a modular system, using one possible connector system to create an array of lights using individual hexagonal housings to create a self supporting-system that can be expanded into multiple patterns. This embodiment utilizes a connector system using an additional connecting piece to be added between the two systems to link the hexagonal housings.

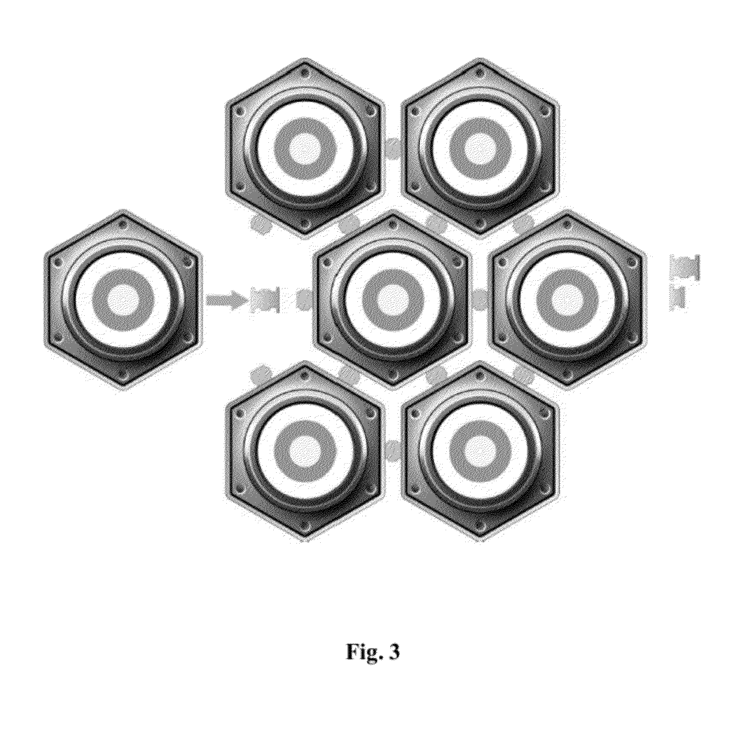

FIG. 4 is an illustration of an example of the present invention in accordance with one of the embodiments as disclosed herein, illustrating one possible embodiment of the fixture creating a modular system, using one possible connector system to create an array of lights using individual hexagonal housings to create a self supporting-system that can be expanded into multiple patterns. This embodiment utilizes a connector system employing tab or flange element that overlaps and is then connected with such connector elements as, but not limited to, bolts, screws, or pegs and sockets.

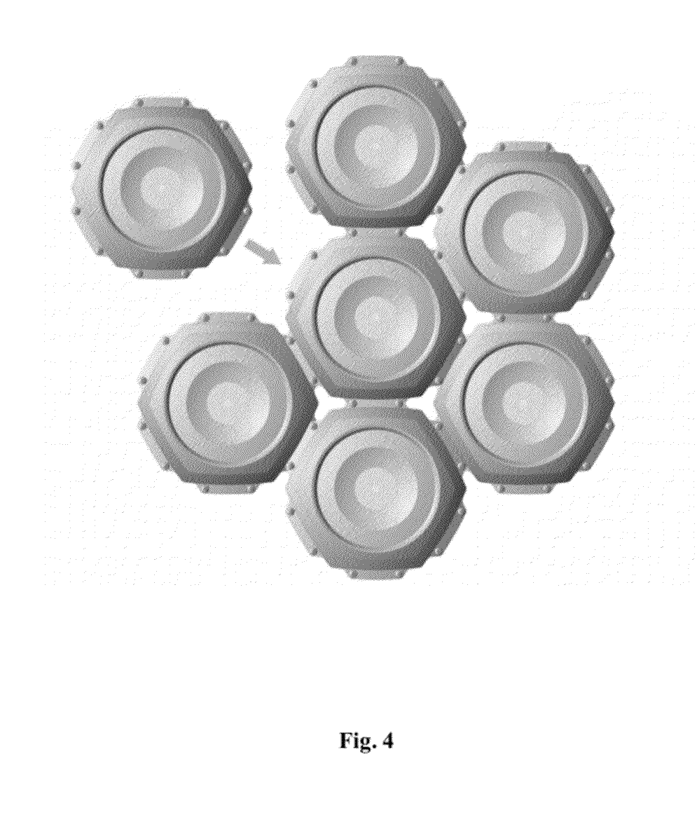

FIG. 5 is an illustration of an example of the present invention in accordance with one of the embodiments as disclosed herein, illustrating one possible embodiment of the fixture creating a modular system, using one possible connector system to create an array of lights using individual hexagonal housings to create a self supporting-system that can be expanded into multiple patterns. This embodiment utilizes a connector system with the additional element of a hexagonal plate to be attached to multiple light housings to create a modular array of in any number of tessellation patterns.

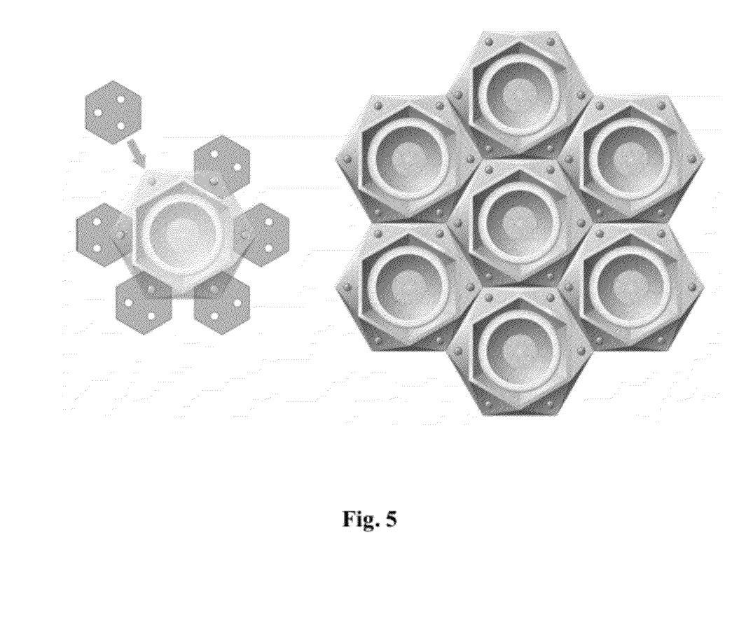

FIG. 6 is an illustration of an example of the present invention in accordance with one of the embodiments as disclosed herein, illustrating one possible embodiment of the fixture creating a modular system, using one possible connector system to create an array of lights using individual hexagonal housings to create a self supporting-system that can be expanded into multiple patterns. This embodiment utilizes a connector system, which employs paired grooves or channels on the exterior of the individual hexagonal housings, which mate and lock with the corresponding channels on other individual hexagonal housing to create modular arrays.

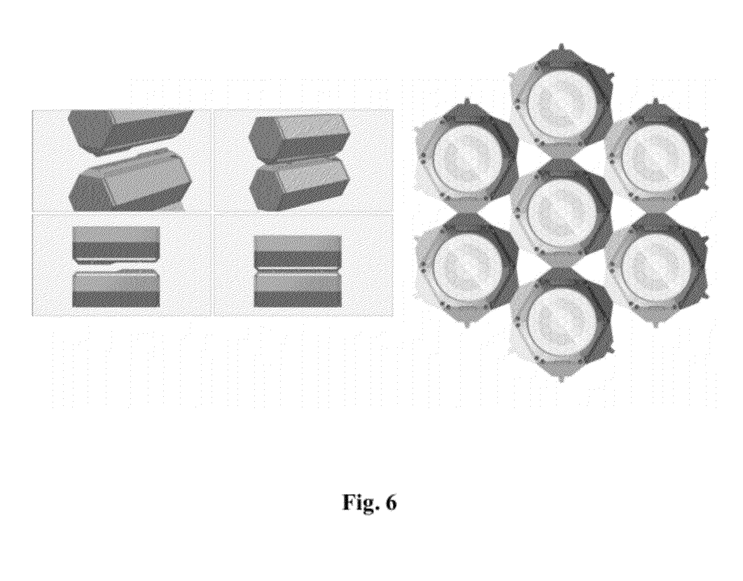

FIG. 7 is an illustration of an example of the present invention in accordance with one of the embodiments as disclosed herein, illustrating one possible embodiment of the fixture creating a modular system, using one possible connector system to create an array of lights using individual hexagonal housings to create a self supporting-system that can be expanded into multiple patterns. This embodiment utilizes a connector system that allows the face or front optical element of the hexagonal housings to be flush. Creating a desired distance between the individual optical elements in each individual housings, to create an optimal distribution of light from the newly formed modular array.

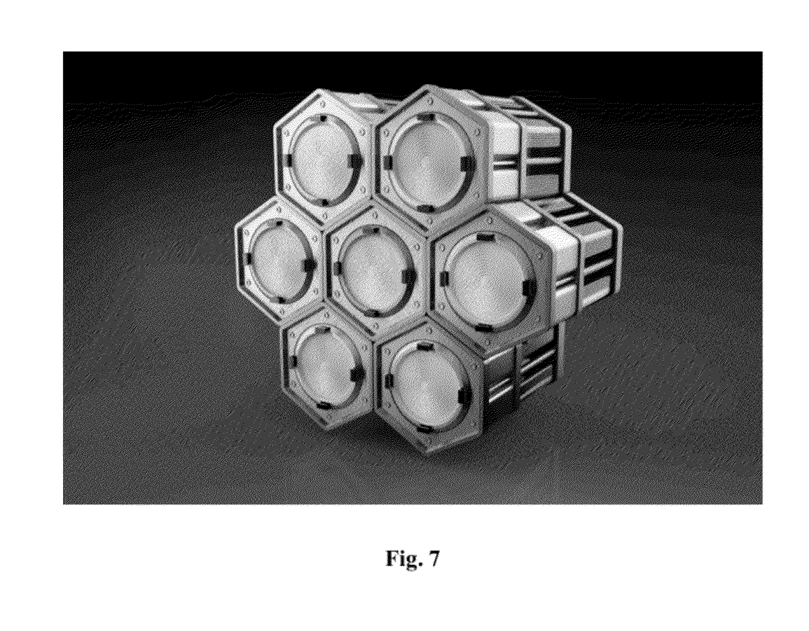

FIG. 8 is an illustration of one possible embodiment of the hexagonal light housing using the same connector system illustrated in FIG. 7 in another possible modular array created using three individual housings.

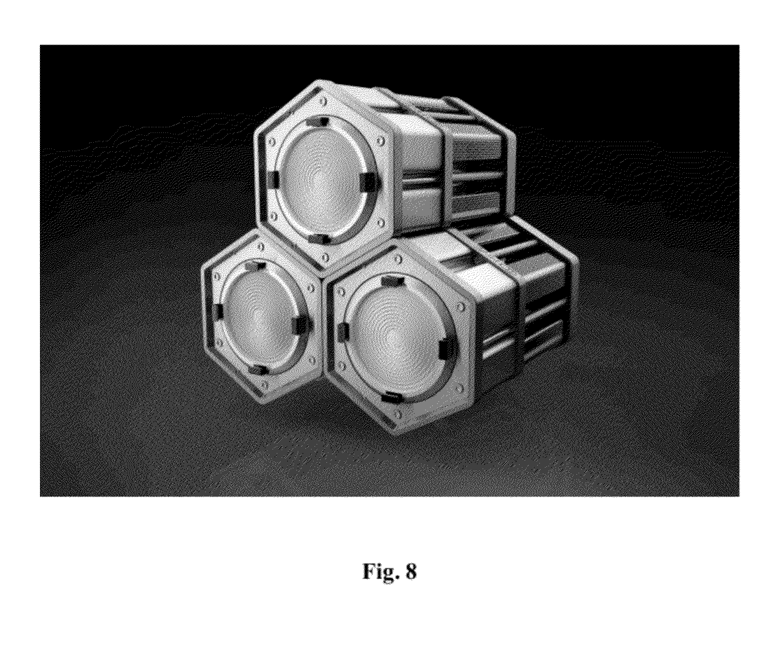

FIG. 9 is an illustration of one possible connecting system, that when combined with two hexagonal housings could be used to join them together, so when multiple connectors and housings are combined, multiple hexagonal arrays can be created. Specifically this connector would involve the use of rods built into the hexagonal housings that could fit through the openings in this connector. One rod from each housing would go through the one of the openings in this connector and when secured would bind the housings together as seen in FIG. 7 and FIG. 8.

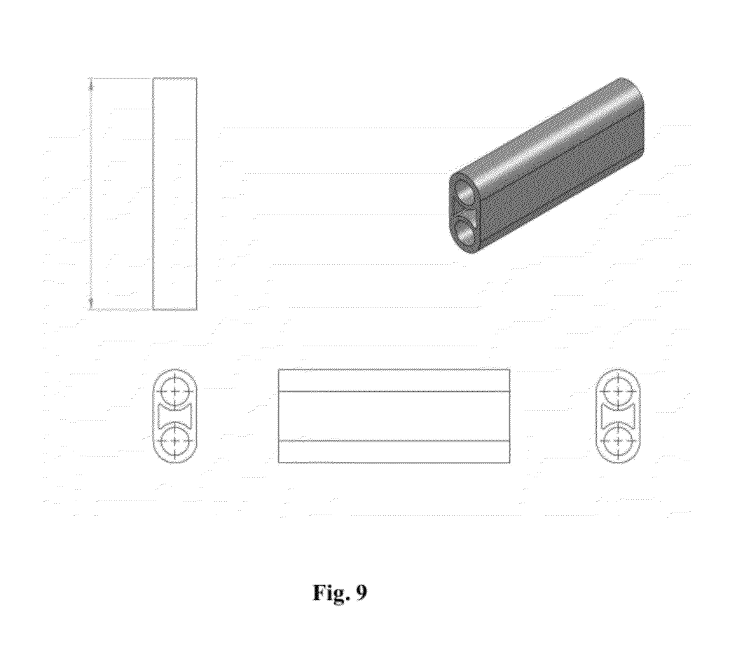

### DETAILED DESCRIPTION OF THE INVENTION

The present invention is generally directed to a hexagonal shaped housing for the entertainment lighting industry that allows for the interconnection of multiple housings through the use of connectors, such as but not limited to bolts, screws, mating or matched sockets, pegs, and or grip connectors, thereby creating a single, larger light source.

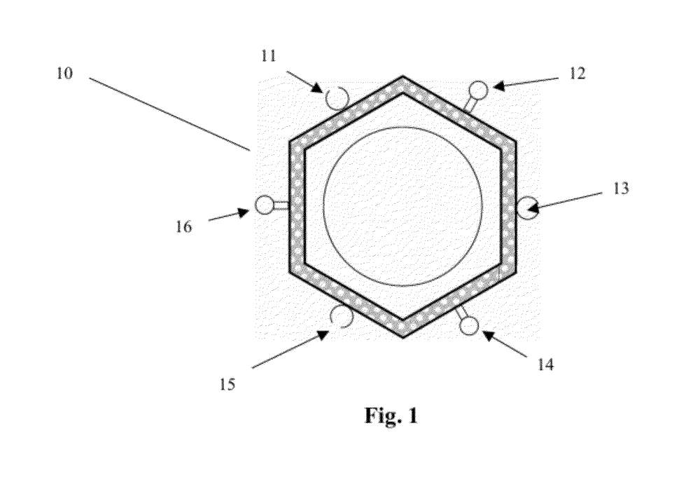

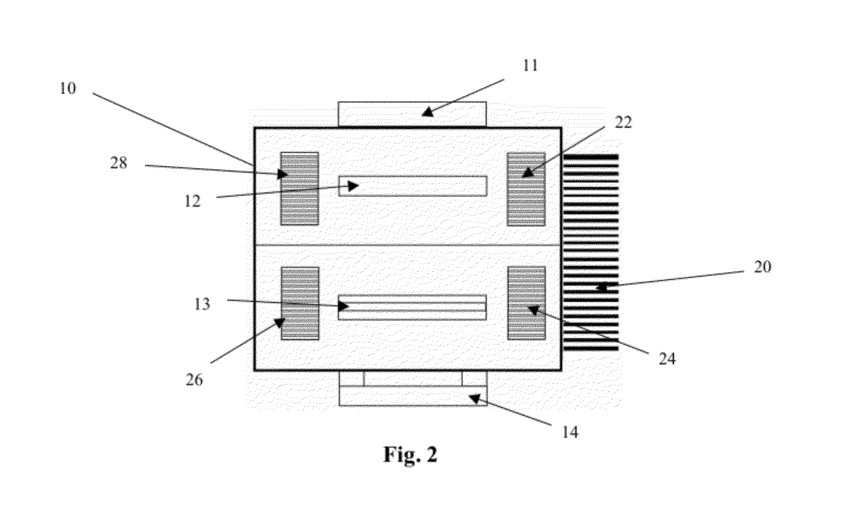

Referring now to the invention in more detail, in FIG. 1 and FIG. 2 there is shown a light housing 10 having a hexagonal shape. The housing design allows for a plurality of housings to be interconnected on any of the housing sides. The housings, when connected, can be built into a variety of combinations to create an infinite variety of single, larger light sources. The housings are capable of connection to each other without additional equipment by means of a grip connection 11-16. At least one grip connection is attached to the external side or sides of the housing, and are either male type grip connections 12, 14, 16, or female type grip connections 11, 13, 15. One embodiment includes grip connections on all six sides of the housing.

In more detail, still referring to the invention of FIG. 1 and FIG. 2, the depicted embodiment has alternating male type grip connections 12, 14, 16 and female type grip connections 11, 13, 15. The male type grip connection 12, 14, 16 has a solid tubular shape positioned away from the external side of the light housing that extends for the majority of the length of the housing. The female type grip connection is of a hollow, tubular shape that extends for the majority of the length of the light housing, and has an opening at its point furthest from the light housing that extends for the length of the grip connection. This opening allows for elastic deformation of the female grip connection so as to permit removable interconnection of a male type grip connection 12, 14, 16, and a female grip connection 11, 13, 15. Another embodiment includes means for ventilation on at least one of the sides of the housing 22, 24, 26, 28 that allows for adequate cooling of the light. Another embodiment includes the addition of a heat sink 20 on the rear of the housing.

In further detail, still referring to the invention of FIG. 1 and FIG. 2, the light housing 10 is of a size to allow for installation of a variety of bulb technologies including but not limited to LEDs, Plasma, Tungsten, HMI and other bulbs. The length of the light housing 10 can range depending on the optical and electronic elements contained within, but in this one preferred embodiment the length ranges from one to sixty inches, and the width ranges from one to thirty-six inches. The grip connections 11-16 will be of a standard size to allow for use with current grip and rigging equipment in the film industry, for example, ⅝″ diameter rods, yoke attachments or other standard attachment points.

The construction details of the invention as shown in FIG. 1 and FIG. 2 are that the light housing 10 may be made of metal or of any other sufficiently rigid and strong material such as high-strength plastic, fiberglass, and the like. Further, the various components of the light housing 10 can be made of different materials. In one embodiment, the light housing 10 is made of anodized and extruded aluminum and heat sink 20 is made of aluminum.

The advantages of the present invention include, without limitation, the ability to combine single lighting units together for a series of modular designs without the purchase or rental of further grip equipment. Such modular designs include: a 7 light “flower” or “honeycomb” pattern to combine 7 single light sources into one large semi-circular light source, a ring of six lights around a camera allowing the creation of an even, high-intensity from-camera light source, and combining 10 or more individual units into grids for the lighting of large areas from a single array. Many other modular designs are possible and not limited by the present invention.

In broad embodiment, the present invention is a hexagonal shaped light housing with at least one connection attached to one of the external sides of the housing.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. An apparatus, comprising:
a light housing containing a light within it, said light housing having a rectangular cross section and at least one connection attached to one of six equal external sides that form a rectangular outer side shape of the light housing, wherein the at least one connection allows a second light housing identical to the light housing to be connected to the light housing.

2. The apparatus of claim 1 further comprising at least one additional light housing identical to the light housing connected to the light housing.

3. The apparatus of claim 1 wherein each of the six equal external sides has a connection attached to it for connecting with a mating attachment of another light housing.

4. The apparatus of claim 3 wherein three of the six equal external sides have a male type grip mating attachment and another three of the six external sides have a female type grip mating attachment, the mating attachments alternating between adjacent external sides from male type grip mating attachment to female type grip mating attachment.

5. The apparatus of claim 3 wherein six additional light housings identical to the light housing can be connected to the light housing, one on each of the six equal external sides.

6. The apparatus of claim 5 wherein six additional light housings identical to the light housing are connected to the light housing, one on each of the six equal external sides.

7. The apparatus of claim 1 wherein the light housing has a heat sink in the rear of the light housing.

8. The apparatus of claim 1 wherein the light housing has a ventilation means.

9. An apparatus, comprising: a tessellation array of two or more light housings, each of the light housings containing a light within it and having a rectangular cross section with six equal external sides that form a rectangular outer side shape of the light housing, each of the light housings being connected to at least one other of the two or more light housings along one of its six equal external sides.

10. The apparatus of claim 9 wherein the tessellation array of two or more light housings is comprised of seven light housings.

11. The apparatus of claim 10 wherein one of the seven light housings is connected to six light housings.

12. The apparatus of claim 9 wherein each of the six equal external sides of each of the light housings in the tessellation array has a connection attached to it for connecting with a mating attachment of another light housing.
